(19) United States
(12) Patent Application Publication
(10) Pub. No.: US 2018/0117900 A1
(43) Pub. Date: May 3, 2018

(54) EDGE TREATMENT FOR DEVELOP-ON-PRESS LITHOGRAPHIC PRINTING MEMBERS

(71) Applicants: Alan DOYLE, Hudson, NH (US); Kevin RAY, Windham, NH (US); Travis SOFTIC, Springfield, MA (US); A. Paul KITSON, West Suffield, CT (US)

(72) Inventors: Alan DOYLE, Hudson, NH (US); Kevin RAY, Windham, NH (US); Travis SOFTIC, Springfield, MA (US); A. Paul KITSON, West Suffield, CT (US)

(21) Appl. No.: 15/377,043

(22) Filed: Dec. 13, 2016

Related U.S. Application Data
(63) Continuation-in-part of application No. 15/342,581, filed on Nov. 3, 2016, now abandoned.

(51) Int. Cl. B41F 7/00

(52) U.S. Cl. CPC B41F 7/00

(57) ABSTRACT

Following cutting of a develop-on-press printing member, a treatment fluid having a pH greater than 6 is applied to one or both edges prior to its development and use in order to avoid ink lines during printing.

### RELATED APPLICATION

This application is a continuation-in-part of U.S. Ser. No. 15/342,581, filed on Nov. 3, 2016, the entire disclosure of which is hereby incorporated by reference.

### BACKGROUND OF THE INVENTION

In offset lithography, a printable image is present on a printing member as a pattern of ink-accepting (oleophilic) and ink-rejecting (oleophobic) surface areas. Once applied to these areas, ink can be efficiently transferred to a recording medium in the imagewise pattern with substantial fidelity. Dry printing systems utilize printing members whose ink-repellent portions are sufficiently phobic to ink as to permit its direct application. In a wet lithographic system, the non-image areas are hydrophilic, and the necessary ink-repellency is provided by an initial application of a dampening fluid to the plate prior to inking. The dampening fluid prevents ink from adhering to the non-image areas, but does not affect the oleophilic character of the image areas. Ink applied uniformly to the printing member is transferred to the recording medium only in the imagewise pattern. Typically, the printing member first makes contact with a compliant intermediate surface called a blanket cylinder which, in turn, applies the image to the paper or other recording medium. In typical sheet-fed press systems, the recording medium is pinned to an impression cylinder, which brings it into contact with the blanket cylinder.

In negative-working plates, the foreground or image areas of the plate receive exposure to a laser or other source of imaging radiation, whereas in positive-working plates, background portions are exposed. The effect of radiation exposure depends on the nature of the plate. For example, where plates are “developed” by subjecting them to the action of a liquid developer following exposure, radiation either “fixes” the topmost layer to render it resistant to the developer (which washes away the unexposed areas) or has the opposite effect, rendering an otherwise developer-resistant layer vulnerable to developer action. Suppose the plate is configured for wet printing and has two layers, an oleophilic layer to receive ink and a hydrophilic layer to receive fountain solution or other aqueous liquid that repels subsequently applied ink; the ink-receiving areas are foreground or image, and areas that do not receive ink are considered background. Because the plate is negative-working, the radiation either renders the oleophilic layer unremovable by development or renders the hydrophilic layer removable. Most negative-working wet plates utilize the former mechanism.

Some plates are designed for development during the print “make ready” process. These “develop on press” (DOP) plates are imaged (i.e., imagewise exposed to actinic radiation) on a conventional platemaker and then mounted on the plate cylinder of a lithographic printing press. The press fountain solution and ink remove the plate's unexposed areas (in negative-working plates), thereby “developing” a polymerized, hardened, exposed ink-receptive image area.

Certain printing jobs call for a plate whose width is smaller than that of the recording medium to which ink is applied; this is particularly common when printing broadsheet newspapers. In a typical operation, the paper is around 0.25 inch (about 6 mm) wider than its associated plate, on each side (so in total, the plate is 0.5 inch (about 12 to 13 mm) narrower than the paper). The paper is typically in web form, although it may also be fed in sheets.

Unfortunately, and particularly in the case of DOP plates, this dimensional mismatch can result in the unwanted appearance of edge artifacts—in particular, thin, continuous lines running along the printed sheet where it encounters the edges of the plate. These “paper lines” are frequently unacceptable, particularly if the page contains full-sized expensive advertising in prestigious newspaper titles. It is believed the plate edge picks up ink for two reasons: either the edge includes a burr (up or down) resulting from cutting the plate (using, e.g., a guillotine or in-line blade) from larger-sized sheets; or a grained and anodized aluminum substrate gets damaged during cutting, leading to micro-cracks forming in its surface, which can pick up unwanted ink. Accordingly, there is a need for techniques of avoiding the appearance of paper lines when using undersized printing plates.

### SUMMARY OF THE INVENTION

It has been found that certain fluids, when applied to the edge of a printing plate prior to its use but following cutting to size, eliminate the paper line problem. Suitable treatment fluids include aqueous alkali (basic) solutions. The pH of the aqueous alkali solution is preferably from 6 to 13.5, more preferably from 8 to 13.5, and particularly preferably from 10 to 13.5. An organic solvent can optionally be added to the treatment fluid. When an organic solvent is added, its proportion is preferably 20% by weight or less, and particularly preferably 10% by weight or less. Without being bound to any particular theory or mechanism, it is believed that these materials passivate the plate edge and thereby reduce its ability to adsorb and transfer ink. The treatment can be applied by hand or by machine applicator, and the plate is typically allowed to dry before mounting (or use). Although the ensuing discussion focuses on negative-working plates for ease of presentation, it should be understood that the invention is equally applicable to positive-working plates.

Accordingly, in a first aspect, the invention pertains to a method of imaging and printing with a lithographic printing member comprising (i) a metal substrate having a hydrophilic surface and (ii) over the substrate, a photopolymer oleophilic layer, the substrate and photopolymer layer having a pair of opposed, common edges defining a width of the printing member. In various embodiments, the method comprises the steps of cutting at least one of the edges of the printing member to reduce the width thereof; exposing the printing member to imaging radiation in an imagewise pattern; exposing substantially only the edges to a solution having a pH greater than 6 (e.g., in the range of 10 to 13.5); following the exposing step, affixing the plate to a printing press; and on the printing press, developing the printing member and thereafter causing transfer of ink in the imagewise pattern to the printing member and thereafter from the printing member to a recording medium having a width greater than the width of the printing member. As a result, the ink transfer does not impart edge artifacts to the recording medium. It should be noted that cutting can take place before or after the exposing step; the key is that cutting takes place prior to treatment of the edges.

In another aspect, the invention pertains to a develop-on-press lithographic printing member. In various embodiments, the printing member comprises a hydrophilic metal substrate; over the substrate, a photopolymer composition curable to an oleophilic state, the photopolymer composition being removable, where unexposed to actinic radiation, from the substrate by exposure to press fountain solution and ink, wherein the substrate and photopolymer layer have a pair of opposed, common edges with ink-retaining imperfections therein; and over at least one of the edges but substantially not on either surface of the printing member, a layer of treatment fluid having a pH greater than 6 (e.g., in the range of 10 to 13.5).

In some embodiments of either or both aspects, the solution is an aqueous solution comprising an alkali agent, e.g., an inorganic or organic alkali compound. The alkali agent may be present in the solution in an amount ranging from 0.005% to 10% by weight, e.g., from 0.05% to 5%. In some embodiments, the solution further comprises an organic solvent. In such embodiments, the organic solvent may be present in the solution in an amount no greater than 10% by weight. The solution may include a surfactant, e.g., in an amount ranging from 1% to 2% by weight.

As used herein, the term “plate” or “member” refers to any type of printing member or surface capable of recording an image defined by regions exhibiting differential affinities for ink and/or fountain solution. Suitable configurations include the traditional planar or curved lithographic plates that are mounted on the plate cylinder of a printing press, but can also include seamless cylinders (e.g., the roll surface of a plate cylinder), an endless belt, or other arrangement.

The term “hydrophilic” is used in the printing sense to connote a surface affinity for a fluid which prevents ink from adhering thereto. Such fluids include water for conventional ink systems, aqueous and non-aqueous dampening liquids, and the non-ink phase of single-fluid ink systems. Thus, a hydrophilic surface in accordance herewith exhibits preferential affinity for any of these materials relative to oil-based materials. Similarly, the term “oleophilic” is used in the printing sense to connote a preferential surface affinity for ink.

The term “substantially” or “approximately” means±10% (e.g., by weight or by volume), and in some embodiments, ±5%. The term “consists essentially of” means excluding other materials that contribute to function or structure. For example, a treatment fluid consisting essentially of water and sodium hydroxide may include other ingredients, such as a surfactant, solvent and/or defoamer, but these do not contribute to the treatment function. (In particular, the surfactant and solvent make the process more efficient—the surfactant allows the fluid to lay down in an even manner, and a solvent improves drying time—and a defoamer controls foam.) Percentages refer to weight percentages unless otherwise indicated.

### DESCRIPTION OF DRAWINGS

The foregoing discussion will be understood more readily from the following detailed description of the invention, when taken in conjunction with the single FIGURE of the drawing, which is a side elevational view of a conventional printing plate treated in accordance with embodiments hereof.

### DETAILED DESCRIPTION

### 1. Imaging Apparatus

Plates treated in accordance herewith typically are imaged in an imaging device by means of a modulated signal, e.g., a modulated near-IR laser. For negative-working plates, the laser is rastered over the plate surface while the laser intensity is modulated according to digital information so that only the background areas of the plate receive exposure. An imaging apparatus suitable for use in conjunction with the present printing members includes at least one laser device that emits in the region of maximum plate responsiveness, i.e., whose λₘₐₓ closely approximates the wavelength region where the plate absorbs most strongly. Specifications for lasers that emit in the near-IR region are fully described in U.S. Pat. Nos. Re. 35,512 (“the '512 patent”) and U.S. Pat. No. 5,385,092 (“the '092 patent”), the entire disclosures of which are hereby incorporated by reference. Lasers emitting in other regions of the electromagnetic spectrum are well-known to those skilled in the art.

Suitable imaging configurations are also set forth in detail in the '512 and '092 patents. Briefly, laser output can be provided directly to the plate surface via lenses or other beam-guiding components, or transmitted to the surface of a blank printing plate from a remotely sited laser using a fiber-optic cable. A controller and associated positioning hardware maintain the beam output at a precise orientation with respect to the plate surface, scan the output over the surface, and activate the laser at positions adjacent selected points or areas of the plate. The controller responds to incoming image signals corresponding to the original document or picture being copied onto the plate to produce a precise negative or positive image of that original. The image signals are stored as a bitmap data file on a computer. Such files may be generated by a raster image processor (“RIP”) or other suitable means. For example, a RIP can accept input data in page-description language, which defines all of the features required to be transferred onto the printing plate, or as a combination of page-description language and one or more image data files. The bitmaps are constructed to define the hue of the color as well as screen frequencies and angles.

The level of the exposure depends on the power of the laser, the size of the laser spot, and the composition of the coating, but is preferably chosen to deliver an area energy density or fluence between 100 and 250 mJ/cm², and more preferably between 125 and 200 mJ/cm². Examples of suitable exposure devices are the COMPASS 8030 and the DIMENSION PRO 800, both provided by Presstek Inc. Other imaging systems, such as those involving light valving and similar arrangements, can also be employed; see, e.g., U.S. Pat. Nos. 4,577,932; 5,517,359; 5,802,034; and 5,861,992, the entire disclosures of which are hereby incorporated by reference. Moreover, it should also be noted that image spots may be applied in an adjacent or in an overlapping fashion.

The imaging device is typically integrated into a platemaker, which exposes the plates, and following exposure, the plate is transferred to a press, where development takes place during the make-ready process. For DOP plates, it is unnecessary to use a processor or other equipment that subjects the plate to the action of a developer composition to remove the exposed portions of the imageable coating.

### 2. Lithographic Printing Members

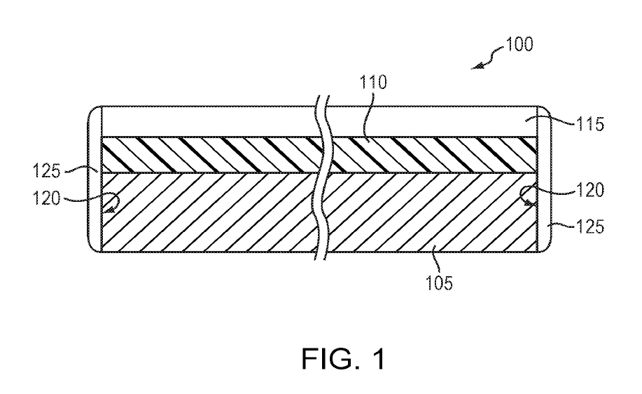

FIG. 1 illustrates a negative-working printing member 100 according to the invention that includes a a hydrophilic substrate 105 and an oleophilic photoresponsive layer 110. Layer 110 is sensitive to imaging (generally IR) radiation as discussed below, and in negative-working embodiments, imaging of the printing member 100 (by exposure to IR radiation) renders the layer insoluble when subjected to fountain solution. Most or all of the layers used in the present invention are continuous. The term “continuous” as used herein means that the underlying surface is completely covered with a uniform layer of the deposited material. Each of the layers and its functions are described in detail below.

2.1 Substrate 105

The substrate provides dimensionally stable mechanical support to the printing member. The substrate should be strong, stable, and flexible. One or more surfaces (and, in some cases, bulk components) of the substrate is hydrophilic, and the substrate itself is desirably metal. In general, metal layers undergo special treatment in order to be capable of accepting fountain solution in a printing environment. Any number of chemical or electrical techniques, in some cases assisted by the use of fine abrasives to roughen the surface, may be employed for this purpose. For example, electrograining involves immersion of two opposed aluminum plates (or one plate and a suitable counterelectrode) in an electrolytic cell and passing alternating current between them. The result of this process is a finely pitted surface topography that readily adsorbs water. See, e.g., U.S. Pat. No. 4,087,341.

A structured or grained surface can also be produced by controlled oxidation, a process commonly called “anodizing.” An anodized aluminum substrate consists of an unmodified base layer and a porous, “anodic” aluminum oxide coating thereover; this coating readily accepts water. Without further treatment, however, the oxide coating would lose wettability due to further chemical reaction. Anodized plates are, therefore, typically exposed to a silicate solution or other suitable (e.g., phosphate) reagent that stabilizes the hydrophilic character of the plate surface. In the case of silicate treatment, the surface may assume the properties of a molecular sieve with a high affinity for molecules of a definite size and shape—including, most importantly, water molecules. The treated surface also promotes adhesion to an overlying photopolymer layer. Anodizing and silicate treatment processes are described in U.S. Pat. Nos. 3,181,461 and 3,902,976. The anodizing thickness is preferably 0.4 to 3 μm thick (as measured by scanning electron microscopy), more preferably 0.7 to 1.5 μm thick, and ideally about 1 μm thick.

Preferred hydrophilic substrate materials include aluminum that has been mechanically, chemically, and/or electrically grained with subsequent anodization. The surface of substrate 105 has characteristics matched to performance of the overlying layer. The thickness of substrate 105 generally ranges from 0.004 to 0.02 inch, with thicknesses in the range 0.005 to 0.012 inch being particularly preferred.

In other embodiments, the hydrophilic surface is provided by a layer that does not itself serve as a substrate—e.g., which is laminated or coated onto a heavier substrate layer.

2.2 Photoresponsive Layer 110

Layer 110 is typically applied as a coating and includes a component polymerizable by a free-radical mechanism. The radiation absorber may be a dye, and the composition may also contain one or more additives such as, for example, a coating surfactant. The amount of polymerizable component (i.e., total amount of aliphatic urethane acrylic oligomer and all other monomer) may be high, e.g., about 60 to 80 wt %.

The polymerizable component comprises, consists essentially of or consists of one or more compounds that have one or more ethylenically unsaturated polymerizable or crosslinkable groups that can be polymerized or crosslinked using free-radical initiation. For example, the polymerizable component can be ethylenically unsaturated monomers, oligomers, and crosslinkable polymers, or various combinations of such compounds. Thus, suitable ethylenically unsaturated compounds that can be polymerized or crosslinked include ethylenically unsaturated polymerizable monomers that have one or more of the polymerizable groups, including unsaturated esters of alcohols, such as (meth)acrylate esters of polyols. Oligomers and/or prepolymers, such as urethane (meth)acrylates, epoxide(meth)acrylates, polyester(meth)acrylates, polyether(meth)acrylates, free-radical crosslinkable polymers, and unsaturated polyester resins can also be used. In some embodiments, the polymerizable component may comprise carboxy groups.

Useful polymerizable components include free-radical polymerizable monomers or oligomers that comprise addition polymerizable ethylenically unsaturated groups including multiple acrylate and methacrylate groups and combinations thereof, or free-radical crosslinkable polymers, or combinations of these classes of materials. More particularly useful polymerizable compounds include those derived from urea urethane(meth)acrylates or urethane(meth)acrylates having multiple polymerizable groups. For example, a suitable polymerizable component can be prepared by reacting DESMODUR N100 aliphatic polyisocyanate resin based on hexamethylene diisocyanate (Bayer Corp., Milford, Conn.) with hydroxyethyl acrylate and pentaerythritol triacrylate. Other preferred polymerizable compounds are available from Sartomer Company, Inc. such as SR399 (dipentaerythritol pentaacrylate), SR355 (di-trimethylolpropane tetraacrylate), SR295 (pentaerythritol tetraacrylate), and others that would be readily apparent to one skilled in the art. Also useful are urea urethane(meth)acrylates and urethane(meth)acrylates described in U.S. Pat. Nos. 6,582,882 and 6,899,994, both of which are incorporated by reference.

Numerous other polymerizable compounds are known to those skilled in the art and are described in the considerable literature including Photoreactive Polymers: The Science and Technology of Resists, A Reiser, Wiley, N.Y., 1989, pp. 102-177; B. M. Monroe in Radiation Curing: Science and Technology, S. P. Pappas, Ed., Plenum, N.Y., 1992, pp. 399-440; and “Polymer Imaging” by A. B. Cohen and P. Walker, in imaging Processes and Material, M. Sturge et al. (Eds.), Van Nostrand Reinhold, N.Y., 1989, pp. 226-262. For example, useful polymerizable components are also described in EP 1,182,033 beginning with paragraph [0170].

The polymerizable component is present in the photoresponsive composition in an amount sufficient to render the composition insoluble in an aqueous medium after exposure to radiation. This is generally from about 20 to about 75 wt % and preferably from about 40 to about 75 wt % based on the dry weight of the photoresponsive composition. For example, the weight ratio of polymerizable component to the polymeric binder may be from about 5:1 to about 1:1, preferably about 3.7:1.

The initiator composition is capable of generating radicals sufficient to initiate polymerization of the polymerizable component upon exposure to the imaging radiation. The initiator composition may be responsive, for example, to electromagnetic radiation in the ultraviolet, visible and/or infrared spectral regions, corresponding to the broad spectral range of from about 150 nm to about 1500 nm. UV and visible light sensitivity is generally from about 150 nm to about 700 nm. Preferably, the initiator composition is responsive to IR or near-IR radiation in the range of from about 600 nm to about 1300 nm, e.g., in the range of from about 700 nm to about 1200 nm. There are numerous compounds known in the literature that can be used in this manner including, but not limited to, organic boron salts, s-triazines, benzoyl-substituted compounds, onium salts, trihaloalkyl-substituted compounds, metallocenes (such as titanocenes), ketoximes, thio compounds, organic peroxides, or a combination of two or more of these classes of compounds.

Other suitable initiator compositions comprise compounds that include but are not limited to, amines (such as alkanol amines), thiol compounds, anilinodiacetic acids or derivatives thereof, N-phenyl glycine and derivatives thereof, N,N-dialkylaminobenzoic acid esters, N-arylglycines and derivatives thereof (such as N-phenylglycine), aromatic sulfonylhalides, trihalogenomethylsulfones, imides (such as N-benzoyloxyphthalimide), diazosulfonates, 9,10-dihydroanthracene derivatives, N-aryl, S-aryl, or O-aryl polycarboxylic acids with at least 2 carboxy groups of which at least one is bonded to the nitrogen, oxygen, or sulfur atom of the aryl moiety (such as aniline diacetic acid and derivatives thereof and other “co-initiators” described in U.S. Pat. No. 5,629,354), oxime ethers and oxime esters (such as those derived from benzoin), α-hydroxy or α-amino-acetophenones, alkyltriarylborates, trihalogenomethylarylsulfones, benzoin ethers and esters, peroxides (such as benzoyl peroxide), hydroperoxides (such as cumyl hydroperoxide), azo compounds (such as azo bis-isobutyronitrile) as described, for example, in U.S. Pat. No. 4,565,769, borate and organoborate salts such as those described in U.S. Pat. No. 6,562,543, and onium salts. Other known initiator composition components are described, for example, in U.S. Patent Publ. No. 2003/0064318.

Particularly useful initiator composition components for UV and visible light sensitive photoresponsive compositions include hexaarylbiimidazoles (also known as triarylimidazolyl dimers) such as, for example, 2,2′-bis(2-chlorophenyl)-4,4′,5,5′-tetraphenyl-biimidazole and 2,2′-bis(o-chlorophenyl-4,4′,5,5′-tetra(m-methoxyphenyl)biimidazole. The triazines noted below can be used with exposure to imaging radiation at about any wavelength including UV and visible radiation exposure. Other UV-photoresponsive free-radical-generating compounds include but are not limited to, trichloromethyl triazines as described, for example, in U.S. Pat. No. 4,997,745 and diaryliodonium salts.

Co-initiators can also be used. Suitable co-initiators include metallocenes (such as titanocenes and ferrocenes), mono- and polycarboxylic acids such as anilino diacetic acid, haloalkyl triazines, thiols or mercaptans (such as mercaptotriazoles), borate salts, and photooxidants containing a heterocyclic nitrogen that is substituted by an alkoxy or acyloxy group, as described in U.S. Pat. No. 5,942,372.

For IR-sensitive photoresponsive compositions, suitable initiator compositions comprise or consist essentially of an onium salt such as a sulfonium, oxysulfoxonium, oxysulfonium, sulfoxonium, ammonium, selenonium, arsonium, phosphonium, diazonium, or halonium salt. Preferred onium salts are iodonium salts, particularly iodonium borate salts. Further details of useful onium salts, including representative examples, are provided in U.S. Patent Publ. No. 2002/0068241, WO 2004/101280 (Munnelly et al.), and U.S. Pat. Nos. 5,086,086, 5,965,319, and 6,051,366, the disclosures of which are hereby incorporated by reference. For example, suitable phosphonium salts include positively charged hypervalent phosphorus atoms with four organic substituents. Suitable sulfonium salts such as triphenylsulfonium salts include a positively charged hypervalent sulfur with three organic substituents. Suitable diazonium salts possess a positively charged azo group (that is, —N═N⁺). Suitable ammonium salts include a positively charged nitrogen atom such as substituted quaternary ammonium salts with four organic substituents, and quaternary nitrogen heterocyclic rings such as N-alkoxypyridinium salts. Suitable halonium salts include a positively charged hypervalent halogen atom with two organic substituents. The onium salts generally include a suitable number of negatively charged counterions such as halides, hexafluorophosphate, thiosulfate, hexafluoroantimonate, tetrafluoroborate, sulfonates, hydroxide, perchlorate, n-butyltriphenyl borate, tetraphenyl borate, and others readily apparent to one skilled in the art.

In one embodiment, the onium salt has a positively-charged iodonium (4-methylphenyl)[4-(2-methylpropyl)phenyl] moiety and a suitable negatively charged counterion. A representative example of such an iodonium salt is available as IRGACURE 250 from Ciba. Specialty Chemicals (Tarrytown, N.Y.) that is (4-methylphenyl)[4-(2-methylpropyl)phenyl]iodonium hexafluorophosphate and is supplied in a 75% propylene carbonate solution.

Useful boron components include organic boron salts having an organic boron anion (such as any of those described in U.S. Pat. No. 6,569,603) that is paired with a suitable cation such as an alkali metal ion, an onium, or a cationic sensitizing dye. Useful onium cations include ammonium, sulfonium, phosphonium, iodonium, and diazonium cations. They may be used alone or in combination with various co-initiators such as heterocyclic mercapto compounds including mercaptotriazoles, mercaptobenzimidazoles, mercaptobenzoxazoles, mercaptobenzothiazoles, mercaptobenzoxadiazoles, mercaptotetrazoles, such as those described in U.S. Pat. No. 6,884,568 in amounts of at least 0.5 and up to and including 10 wt % based on the total solids of the photoresponsive composition.

Some initiator compositions include one or more azine compounds as described, for example, in U.S. Pat. No. 6,936,384. These compounds are organic heterocyclic compounds containing a 6-membered ring formed from carbon and nitrogen atoms. Azine compounds include heterocyclic groups such as pyridine, diazine, and triazine groups, as well as polycyclic compounds having a pyridine, diazine, or triazine substituent fused to one or more aromatic rings such as carbocyclic aromatic rings. Thus, the azine compounds include, for example, compounds having a quinoline, isoquinoline, benzodiazine, or naphthodiazine substituent. Both monocyclic and polycyclic azine compounds are useful.

Useful azine compounds include triazine compounds that have a 6-membered ring containing 3 carbon atoms and 3 nitrogen atoms such as those described in U.S. Pat. Nos. 6,309,792, 6,010,824, 5,885,746, 5,496,903, and 5,219,709. The azinium form of azine compounds can also be used if desired. In azinium compounds, a quaternizing substituent of a nitrogen atom in the azine ring is capable of being released as a free radical. The alkoxy substituent that quaternizes a ring nitrogen atom of the azinium nucleus can be selected from among a variety of alkoxy substituents.

Halomethyl-substituted triazines, such as trihalomethyl triazines, are particularly useful in the initiator composition. Representative compounds of this type include but are not limited to, 1,3,5-triazine derivatives—such as those having 1 to 3 —CX₃ groups, where each X independently represents a chlorine or bromine atom—including polyhalomethyl-substituted triazines and other triazines, such as 2,4-trichloromethyl-6-methoxyphenyl triazine, 2-phenyl-4,6-bis(trichloromethyl)-s-triazine,2,4,6-tris(trichloromethyl)-s-triazine, 2-methyl-4,6-bis(trichloromethyl)-s-triazine, 2-(styryl-4,6-bis(trichloromethyl)-s-triazine, 2-(p-methoxystyryl)-4,6-bis(trichloromethyl)-s-triazine, 2-(4-methoxy-naphtho-1-yl)-4,6-bis(trichloromethyl)-s-triazine, 2-(4-ethoxynaphtho-1-yl)-4,6-bis(trichloromethyl)-s-triazine, and 2-(4-(2-ethoxyethyl)-naphtho-1-yl)-4,6-bis(trichloromethyl)-s-triazine], 2-(4-methylthiophenyl)-4,6-bis(trichloromethyl)-2-triazine, 2-(4-chlorophenyl-4,6-bis(trichloromethyl)-2-triazine, 2,4,6-tri(trichloromethyl)-2-triazine, and 2,4,6-tri(tribromomethyl)-2-triazine. The azine compounds and particularly the triazine compounds may be used alone or in combination with one or more co-initiators such as titanocenes, mono- and polycarboxylic acids, hexaarylbisimidazoles, as described, for example, in U.S. Pat. No. 4,997,745 that is incorporated herein by reference.

In some embodiments, the photoresponsive composition also includes a mercaptan derivative such as a mercaptotriazole such as 3-mercapto-1,2,4-triazole, 4-methyl-3-mercapto-1,2,4-triazole, 5-mercapto-1-phenyl-1,2,4-triazole, 4-amino-3-mercapto-1,2,4,-triazole, 3-mercapto-1,5-diphenyl-1,2,4-triazole, and 5-(p-aminophenyl)-3-mercapto-1,2,4-triazole. Various mercaptobenzimidazoles, mercaptobenzothiazoles, and mercaptobenzoxazoles may also be present.

Thus, several initiator/co-initiator combinations can be used in various embodiments of the present invention, including:
a) a triazine in combination with a co-initiator that is an N-aryl, S-aryl, or O-aryl polycarboxylic acids with at least 2 carboxy groups of which at least one is bonded to the nitrogen, oxygen, or sulfur atom of the aryl moiety (such as aniline diacetic acid and derivatives thereof),
b) a triazine in combination with a co-initiator that is a mercaptan derivative as described above,
c) an iodonium salt (such as an iodonium borate) in combination with a co-initiator that is a metallocene (for example a titanocene or ferrocene) as described, for example, in U.S. Pat. No. 6,936,384, and
d) an iodonium salt (such as an iodonium borate) in combination with a co-initiator that is a mercaptotriazole.

The initiator compositions may comprise or consist essentially of one or more diaryliodonium borate compounds, each of which is represented by the following structure:

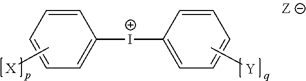

where X and Y are independently halo groups (for example, fluoro, chloro, or bromo), substituted or unsubstituted alkyl groups having 1 to 20 carbon atoms (for example, methyl, chloromethyl, ethyl, 2-methoxyethyl, n-propyl, isopropyl, isobutyl, n-butyl, t-butyl, all branched and linear pentyl groups, 1-ethylpentyl, 4-methylpentyl, all hexyl isomers, all octyl isomers, benzyl, 4-methoxybenzyl, p-methylbenzyl, all dodecyl isomers, all icosyl isomers, and substituted or unsubstituted mono- and poly-, branched and linear haloalkyls), substituted or unsubstituted alkyloxy having 1 to 20 carbon atoms (for example, substituted or unsubstituted methoxy, ethoxy, iso-propoxy, t-butoxy, (2-hydroxytetradecyl)oxy, and various other linear and branched alkyleneoxyalkoxy groups), substituted or unsubstituted aryl groups having 6 or 10 carbon atoms in the carbocyclic aromatic ring (such as substituted or unsubstituted phenyl and naphthyl groups including mono- and polyhalophenyl and naphthyl groups), or substituted or unsubstituted cycloalkyl groups having 3 to 8 carbon atoms in the ring structure (for example, substituted or unsubstituted cyclopropyl, cyclopentyl, cyclohexyl, 4-methylcyclohexyl, and cyclooctyl groups). X and Y may be independently substituted or unsubstituted alkyl groups having 1 to 8 carbon atoms, alkyloxy groups having 1 to 8 carbon atoms, or cycloalkyl groups having 5 or 6 carbon atoms in the ring; for example, X and Y may be independently substituted or unsubstituted alkyl groups having 3 to 6 carbon atoms (and particularly branched alkyl groups having 3 to 6 carbon atoms). Thus, X and Y can be the same or different groups, the various X groups can be the same or different groups, and the various Y groups can be the same or different groups. Both “symmetric” and “asymmetric” diaryliodonium borate compounds are contemplated by this invention but the “symmetric” compounds are preferred (that is, they have the same groups on both phenyl rings). In addition, two or more adjacent X or Y groups can be combined to form a fused carbocyclic or heterocyclic ring with the respective phenyl groups. The X and Y groups can be in any position on the phenyl rings but preferably they are at the 2- or 4-positions, and more preferably at the 4-position, on either or both phenyl rings.

Z⁻ is an organic borate anion represented by the following structure:

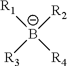

where R₁, R₂, R₃, and R₄ are independently substituted or unsubstituted alkyl groups having 1 to 12 carbon atoms (such as methyl, ethyl, n-propyl, iso-propyl, n-butyl, isobutyl, t-butyl, all pentyl isomers, 2-methylpentyl, all hexyl isomers, 2-ethylhexyl, all octyl isomers, 2,4,4-trimethylpentyl, all nonyl isomers, all decyl isomers, all undecyl isomers, all dodecyl isomers, methoxymethyl, and benzyl) other than fluoroalkyl groups, substituted or unsubstituted carbocyclic aryl groups having 6 to 10 carbon atoms in the aromatic ring (such as phenyl, p-methylphenyl, 2,4-methoxyphenyl, naphthyl, and pentafluorophenyl groups), substituted or unsubstituted alkenyl groups having 2 to 12 carbon atoms (such as ethenyl, 2-methylethenyl, allyl, vinylbenzyl, acryloyl, and crotonotyl groups), substituted or unsubstituted alkynyl groups having 2 to 12 carbon atoms (such as ethynyl, 2-methylethynyl, and 2,3-propynyl groups), substituted or unsubstituted cycloalkyl groups having 3 to 8 carbon atoms in the ring structure (such as cyclopropyl, cyclopentyl, cyclohexyl, 4-methylcyclohexyl, and cyclooctyl groups), or substituted or unsubstituted heterocyclyl groups having 5 to 10 carbon, oxygen, sulfur, and nitrogen atoms (including both aromatic and non-aromatic groups, such as substituted or unsubstituted pyridyl, pyrimidyl, furanyl, pyrrolyl, imidazolyl, triazolyl, tetrazoylyl, indolyl, quinolinyl, oxadiazolyl, and benzoxazolyl groups). Alternatively, two or more of R₁, R₂, R₃ and R₄ can be joined together to form a heterocyclic ring with the boron atom, such rings having up to 7 carbon, nitrogen, oxygen, or nitrogen atoms.

R₁, R₂, R₃, and R₄ may be independently substituted or unsubstituted alkyl or aryl groups, and at least 3 of R₁, R₂, R₃, and R₄ may be the same or different substituted or unsubstituted aryl groups (such as substituted or unsubstituted phenyl groups). In some embodiments, all of R₁, R₂, R₃, and R₄ are the same or different substituted or unsubstituted aryl groups, e.g., all of the groups may be the same substituted or unsubstituted phenyl group. Z⁻ may be a tetraphenyl borate where the phenyl groups are substituted or unsubstituted.

Representative iodonium borate compounds useful in this invention include but are not limited to, 4-octyloxyphenyl phenyliodonium tetraphenylborate, [4-[(2-hydroxytetradecyl)-oxy]phenyl]phenyliodonium tetraphenylborate, bis(4-t-butylphenyl)iodonium tetraphenylborate, 4-methylphenyl-4′-hexylphenyliodonium tetraphenylborate, 4-methylphenyl-4′-cyclohexylphenyliodonium tetraphenylborate, bis(t-butylphenyl)iodonium tetrakis(pentafluorophenyl)borate, 4-hexylphenyl-phenyliodonium tetraphenylborate, 4-methylphenyl-4′-cyclohexylphenyliodonium n-butyltriphenylborate, 4-cyclohexylphenyl-phenyliodonium tetraphenyl borate, 2-methyl-4-t-butylphenyl-4′-methylphenyliodonium tetraphenylborate, 4-methylphenyl-4′-pentylphenyliodonium tetrakis[3,5-bis(trifluoromethyl)phenyl]-borate, 4-methoxyphenyl-4′-cyclohexylphenyliodonium tetrakis(pentafluorophenyl)borate, 4-methylphenyl-4′-dodecylphenyliodonium tetrakis(4-fluorophenyl)borate, bis(dodecylphenyl)iodonium tetrakis(pentafluorophenyl)borate, and bis(4-t-butylphenyl)iodonium tetrakis(1-imidazolyl)borate Preferred compounds include bis(4-t-butylphenyl)iodonium tetraphenylborate, 4-methylphenyl-4′-hexylphenyliodonium tetraphenylborate, 2-methyl-4-t-butylphenyl-4′-methylphenyliodonium tetraphenylborate, and 4-methylphenyl-4′-cyclohexylphenyliodonium tetraphenylborate. Mixtures of two or more of these compounds can also be used in the initiator composition. The diaryliodonium borate compounds can be prepared, in general, by reacting an aryl iodide with a substituted or unsubstituted arene, followed by an ion exchange with a borate anion. Details of various preparatory methods are described in U.S. Pat. No. 6,306,555, and references cited therein, and in Crivello, J. Polymer Sci., Part A: Polymer Chemistry, 37, 4241-4254 (1999).

The initiator composition including one or more initiator compounds is generally present in the photoresponsive composition in an amount of from about 0.5% to about 30%, based on the total solids of the photoresponsive composition or the thy weight of the coated layer. The initiator composition may, for example, be present in an amount of from about 2% to about 20 wt %. In various embodiments, one or more diaryliodonium borate compounds generally comprise from about 10 to about 100% of the initiator composition.

Polymeric binders can be any of those known in the art for use in negative-working photoresponsive compositions. These polymeric binders generally have a molecular weight of from about 2,000 to about 1,000,000 and preferably from about 10,000 to about 200,000. The acid value (mg KOH/g) of the polymeric binder is generally from about 20 to about 400 as determined using known methods. Such polymeric binders can be particulate or film-forming in nature. Furthermore, in some embodiments, the polymeric binder takes part in the polymerization reaction; for example, the polymer binder may contain ethylenic unsaturation.

Examples of polymeric binders include, but are not limited to, those derived at least in part from one or more monomers having pendant carboxyl groups such as (meth)acrylic acids, (meth)acrylates, (meth)acrylamides, (meth)acrylonitriles, poly(alkylene glycols), poly(alkylene glycol)(meth)acrylates, vinyl acetals, styrene and substituted styrenes, N-substituted cyclic imides or maleic anhydrides, such as those described in EP 1,182,033 and U.S. Pat. Nos. 6,309,792, 6,352,812, 6,569,603, and 6,893,797. Phenolic resins may also be used. Also useful are the vinyl carbazole polymers having pendant N-carbazole moieties including those described in U.S. Pat. No. 4,774,163 and polymers having pendant vinyl groups including those described in U.S. Pat. Nos. 6,899,994 and 4,511,645, and EP 1,182,033. In some embodiments, polymers derived from one or more monomers with pendant carboxy groups, (meth)acrylates, styrene and styrene derivatives, vinyl acetal, N-substituted cyclic imides, maleic anhydride, vinyl carbazoles, monomers with multiple vinyl groups, (meth)acrylonitriles, (meth)acrylamides, poly(alkylene glycols), poly(alkylene glycol) (meth)acrylates, and N-substituted (meth)acrylamides are employed as polymeric binders.

Other useful polymeric binders are dispersible or soluble in water or water/′solvent mixtures such as fountain solutions. Such polymeric binders include polymeric emulsions, dispersions, or graft polymers having pendant poly(alkyleneoxide) side chains that can augment the plate's amenability to on-press development by subjection to fountain solution. Such polymeric binders are described, for example, in U.S. Pat. Nos. 6,582,882 and 6,899,994. Other useful polymeric binders have hydrophobic backbones and comprise both of the following a) and b) recurring units, or the b) recurring units alone:
a) recurring units having pendant cyano groups attached directly to the hydrophobic backbone, and
b) recurring units having pendant groups comprising poly(alkylene oxide) segments.

These polymeric binders may comprise poly(alkylene oxide) segments and preferably polyethylene oxide) segments. They can, for example, be graft copolymers having a main chain polymer and poly(alkylene oxide) pendant side chains or segments or block copolymers having blocks of (alkylene oxide)-containing recurring units and non(alkylene oxide)-containing recurring units. Both graft and block copolymers can additionally have pendant cyano groups attached directly to the hydrophobic backbone. The alkylene oxide constitutional units are generally C₁ to C₆ alkylene oxide groups, and more typically C₁ to C₃ alkylene oxide groups. The alkylene portions can be linear or branched or substituted versions thereof.

In some embodiments, the polymeric binders contain only recurring units comprising poly(alkylene oxide) segments, but in other embodiments, the polymeric binders comprise recurring units comprising the poly(alkylene oxide) segments as well as recurring units having pendant cyano groups attached directly to the hydrophobic backbone. By way of example only, such recurring units can comprise pendant groups comprising cyano, cyano-substituted alkylene groups, or cyano-terminated alkylene groups. Recurring units can also be derived from ethylenically unsaturated polymerizable monomers such as acrylonitrile, methacrylonitrile, methyl cyanoacrylate, ethyl cyanoacrylate, or a combination thereof. However, cyano groups can be introduced into the polymer by other conventional means. Examples of such cyano-containing polymeric binders are described, for example, in U.S. Patent Publ. No. 2005/003285. By way of example, suitable polymeric binders can be formed by polymerization of a combination or mixture of suitable ethylenically unsaturated polymerizable monomers or macromers, such as:
A) acrylonitrile, methacrylonitrile, or a combination thereof,
B) poly(alkylene oxide) esters of acrylic acid or methacrylic acid, such as polyethylene glycol) methyl ether acrylate, poly(ethylene glycol) methyl ether methacrylate, or a combination thereof, and
C) optionally, monomers such as acrylic acid, methacrylic acid, styrene, hydroxystyrene, acrylate esters, methacrylate esters, acrylamide, methacrylamide, or a combination of such monomers.

The amount of the poly(alkylene oxide) segments in these polymeric binders may be from about 0.5 to about 60 wt %, e.g., from about 2 to about 50 wt %, from about 5 to about 40 wt %, or from about 5 to about 20 wt %. The amount of (alkylene oxide) segments in the block copolymers is generally from about 5 to about 60 wt %, e.g., from about 10 to about 50 wt %, or from about 10 to about 30 wt %. It is also possible that the polymeric binders having poly(alkylene oxide) side chains are present in the form of discrete particles.

Still other polymeric binders are represented by the following structure:

-(A)ₓ-(B)_{y}—(C)_{z}—

where A represents recurring units comprising a pendant —C(═O)O—CH₂CH═CH₂ group, B represents recurring units comprising pendant cyano groups, and C represents recurring units other than those represented by A and B and optionally including recurring units having pendant carboxy groups (for example, recurring units in which the carboxy groups are not converted to —C(═O)O—CH₂CH═CH₂ groups), B may represent recurring units derived from (meth)acrylonitrile, and C represents recurring units derived from one or more (meth)acrylic acid esters, (meth)acrylamides, vinyl carbazole, styrene and styrenic derivatives thereof, N-substituted maleimides, (meth)acrylic acid, maleic anhydride, vinyl acetate, vinyl ketones (such as vinyl methyl ketone), vinyl pyridines, N-vinyl pyrrolidones, 1-vinylimidazole, and vinyl polyalkylsilanes (such as vinyl trimethylsilane), For example, B may represent recurring units derived from acrylonitrile, with C derived from one or more of methacrylic acid, acrylic acid, vinyl carbazole, methyl methacrylate, 2-hydroxyethyl methacrylate, styrene, and N-phenylmaleimide.

The polymeric binders represented by the above structure are generally present in the photoresponsive composition (and imageable layer) in an amount of from about 10 to about 70 wt %, based on the total composition or layer solids. In some embodiments, the amount is from about 20 to about 50 wt %. The polymeric binders described above can be present in an amount of from about 1.5 to about 75%, e.g., from about 1.5 to about 40%, based on the total solids content of the photoresponsive composition or the dry weight of the imageable layer prepared there from.

The photoresponsive compositions also include a radiation-absorbing compound (sometimes called a “sensitizer”) that is sensitive to radiation at a desired wavelength. These compounds absorb the radiation and facilitate polymerization during imaging. The radiation-absorbing compounds can be sensitive to radiation having a wavelength of from about 150 to about 1400 nm. The compounds sensitive to UV and visible radiation generally have a λₘₐₓ of from about 150 to about 600 nm, e.g., from about 200 to about 550 nm.

In some embodiments, the photoresponsive composition contains a UV sensitizer where the free-radical generating compound is UV radiation sensitive (that is, at least 250 nm and up to and including 450 nm), thereby facilitating photopolymerization. Typical UV photoresponsive free-radical generating compounds are described above. In some preferred embodiments, the radiation sensitive compositions are sensitized to “violet” radiation in the range of at least 375 nm and up to and including 450 nm. Useful sensitizers for such compositions include certain pyrilium and thiopyrilium dyes and 3-ketocoumarins (particularly in combination with a polycarboxylic acid free radical generating compound, such as anilino-N,N-diacetic acid).

Sensitizers that absorb in the visible region of the electromagnetic spectrum (that is, at least 400 nm and up to and including 650 nm) can also be used. Examples of such sensitizers are well known in the art and include the compounds described in cols. 17-22 of U.S. Pat. No. 6,569,603, the disclosure of which is incorporated herein by reference. Other useful visible and UV-sensitive sensitizing compositions include a cyanine dye, diaryliodonium salt, and a co-initiator (as described above) as disclosed in U.S. Pat. No. 5,368,990. Other useful sensitizers for the violet/visible region of sensitization are the 2,4,5-triaryloxazole derivatives as described in WO 2004/074930, which is incorporated herein by reference. These compounds can be used alone or with a co-initiator as described above, and especially with the 1,3,5-triazines described above or with thiol compounds. Useful 2,4,5-triaryloxazole derivatives can be represented by the Structure G-(Ar₁)₃ wherein Ar₁ is the same or different, substituted or unsubstituted carbocyclic aryl group having 6 to 12 carbon atoms in the ting, and G is a furan, oxazole, or oxadiazole ring. The Ar₁ groups can be substituted with one or more halo, substituted or unsubstituted alkyl, substituted or unsubstituted cycloalkyl, substituted or unsubstituted aryl, amino (primary, secondary, or tertiary), or substituted or unsubstituted alkoxy or aryloxy groups. Thus, the aryl groups can be substituted with one or more R′₁ through R′₃ groups, respectively, that are independently hydrogen or a substituted or unsubstituted alkyl group having from 1 to 20 carbon atoms (such as methyl, ethyl, iso-propyl, n-hexyl, benzyl, and methoxymethyl groups) substituted or unsubstituted carbocyclic aryl group having 6 to 10 carbon atoms in the ring (such as phenyl, naphthyl, 4-methoxyphenyl, and 3-methylphenyl groups), substituted or unsubstituted cycloalkyl group having 5 to 10 carbon atoms in the ring, a —N(R′₄)(R′₅) group, or a —OR′₆ group where R′₄ through R′₆ independently represent substituted or unsubstituted alkyl or aryl groups as defined above. At least one of R′₁ through R′₃ may be an —N(R′₄)(R′₅) group where R′₄ and R′₅ are the same or different alkyl groups. Substituents for each Ar₁ group include the same or different primary, secondary, and tertiary amines, e.g., the same dialkylamines.

Still another class of useful violet/visible radiation sensitizers includes compounds represented by the structure Ar₁-G-Ar₂ where Ar₁ and Ar₂ are the same or different substituted or unsubstituted aryl groups having 6 to 12 carbon atoms in the ring, or Ar₂ can be an arylene-G-Ar₁ or arylene-G-Ar₂ group, and G is a furan, oxazole, or oxadiazole ring. Ar₁ is the same as defined above, and Ar₂ can be the same or different aryl group as Ar₁. “Arylene” can be any of the aryl groups defined for Ar₁ but with a hydrogen atom removed to render them divalent in nature.

Additional useful “violet”-visible radiation sensitizers are described in WO 2004/074929. These compounds comprise the same or different aromatic heterocyclic groups connected with a spacer moiety that comprises at least one carbon-carbon double bond that is conjugated to the aromatic heterocyclic groups, and are represented in more detail by Formula (I) of the noted publication.

In the commercial applications of primary interest, the radiation-absorbing compounds are sensitive to IR and near-IR radiation, that is, a wavelength of from about 600 to about 1400 nm, e.g., from about 700 to about 1200 nm. Such near-IR, absorbers include carbon blacks and other IR-absorbing pigments and various IR-sensitive dyes (“IR dyes”), which are preferred. Examples of suitable IR dyes include but are not limited to, azo dyes, squarilium dyes, croconate dyes, triarylamine dyes, thiazolium dyes, indolium dyes, oxonol dyes, oxaxolium dyes, cyanine dyes, merocyanine dyes, phthalocyanine dyes, indocyanine dyes, indotricarbocyanine dyes, oxatricarbocyanine dyes, thiocyanine dyes, thiatricarbocyanine dyes, merocyanine dyes, cryptocyanine dyes, naphthalocyanine dyes, polyaniline dyes, polypyrrole dyes, polythiophene dyes, chalcogenopyryloarylidene and bi(chalcogenopyrylo)polymethine dyes, oxyindolizine dyes, pyrylium dyes, pyrazoline azo dyes, oxazine dyes, naphthoquinone dyes, anthraquinone dyes, quinoneimine dyes, methine dyes, arylmethine dyes, squarine dyes, oxazole dyes, croconine dyes, porphyrin dyes, and any substituted or ionic form of the preceding dye classes. Suitable dyes are also described in U.S. Pat. Nos. 5,208,135, 6,569,603, and 6,787,281, and EP Publication 1,182,033. A general description of one class of suitable cyanine dyes is shown by the formula in paragraph [0026] of WO 2004/101280. In addition to low-molecular-weight IR-absorbing dyes, IR dye moieties bonded to polymers can be used as well. Moreover, IR dye cations can be used as well, that is, the cation is the IR-absorbing, portion of the dye salt that ionically interacts with a polymer comprising carboxy, sun, phospho, or phosphono groups in the side chains.

Near-IR-absorbing cyanine dyes are also useful and are described, for example, in U.S. Pat. Nos. 6,309,792, 6,264,920, 6,153,356, and 5,496,903. Suitable dyes may be formed using conventional methods and starting materials or obtained from various commercial sources including American Dye Source (Baie D'Urfe, Quebec, Canada) and FEW Chemicals (Germany). Other useful dyes for near infrared diode laser beams are described, for example, in U.S. Pat. No. 4,973,572.

Useful IR-absorbing compounds include carbon blacks, e.g., carbon blacks that are surface-functionalized with solubilizing groups are well known in the art. Carbon blacks that are grafted to hydrophilic, nonionic polymers, such as FX-GE-003 (manufactured by Nippon Shokubai), or which are surface-functionalized with anionic groups, such as CAB-O-JET 200 or CAB-O-JET® 300 (manufactured by the Cabot Corporation) are also useful.

The radiation absorber is present in sufficient amounts to sensitize the coating to laser radiation produced by a laser. For example, the radiation-absorbing compound can be present in the photoresponsive composition in an amount generally of from about 1% to about 20% and preferably from about 1.5 to about 10%, based on total solids in the composition that also corresponds to the total dry weight of the imageable layer. Alternatively, the amount can be defined by an absorbance in the range of from about 0.05 to about 3, and preferably of from about 0.1 to about 1.5, in the dry film as measured by reflectance UV-visible spectrophotometry. The particular amount needed for this purpose would be readily apparent to one skilled in the art, depending upon the specific compound used.

Printing members are formed by suitable application of a photoresponsive composition as described above to substrate 105 to form an imageable layer. Substrate 105 can be treated or coated in various ways as described above prior to application of the photoresponsive composition. If substrate 105 has been treated to provide an “interlayer” for improved adhesion or hydrophilicity, the applied photoresponsive composition is generally considered the “top” or outermost layer.

While there is usually no need to apply what is conventionally known as an overcoat (such as an oxygen impermeable topcoat) to the imageable layer(s) as described in WO 99/06890, it can be used if desired. Such overcoat layers or topcoats (indicated at 115 in FIG. 1) can comprise one or more water-soluble polymers such as poly(vinyl alcohol), poly(vinyl pyrrolidone), poly(vinyl imidazole), and water-based acrylic copolymers. Alternatively or in addition, polyurethane-acrylic) hybrid particles (such as the HYBRIDUR material from Air Products and Chemicals) can be used; these hybrid materials are described, for example, in U.S. Pat. No. 7,452,638 at col. 10, line 11 to line 23, and line 60 to col. 11, line 5. Overcoat coat weights typically range from 0.1 to 1.0 g/m², and preferably from 0.1 to 0.4 g/m².

The photoresponsive composition can be applied to substrate 105 as a solution or dispersion in a coating liquid using any suitable equipment and procedure, such as spin coating, knife coating, gravure coating, die coating, slot coating, bar coating, wire rod coating, roller coating, or extrusion hopper coating. The composition can also be applied by spraying onto a suitable support.

Illustrative of such manufacturing methods is mixing the polymerizable component, initiator composition, radiation-absorbing compound, polymeric binder(s), and any other components of the photoresponsive composition in a suitable organic solvent (such as methyl ethyl ketone (2-butanone), methanol, ethanol, 1-methoxy-2-propanol, iso-propyl alcohol, acetone, γ-butyrolactone, n-propanol, tetrahydrofuran, and others readily known in the art, as well as mixtures thereof), applying the resulting solution to a substrate, and removing the solvent(s) by evaporation under suitable drying conditions. Representative coating solvents and imageable layer formulations are described in the examples below. After proper drying, the coating weight of the imageable layer is generally from about 0.1 to about 5 g/m², preferably from about 0.5 to about 3.5 g/m², and more preferably from about 0.5 to about 2 g/m².

The imageable elements have any useful form including but not limited to, printing plate precursors, printing cylinders, printing sleeves and printing tapes (including flexible printing webs). The imageable members are printing plate precursors that can be of any useful size and shape (for example, square or rectangular) having the requisite imageable layer disposed on a suitable substrate. Printing cylinders and sleeves are known as rotary printing members having the substrate and imageable layer in a cylindrical form. Hollow or solid metal cores can be used as substrates for printing sleeves.

### 3. Edge Treatment

After the printing member 100 is cut to its final size, the edges 120 can undesirably carry and transfer ink. Accordingly, they are treated by manual or automated application of a treatment fluid 125 along the edges 120, followed by drying (e.g., air drying, fan-assisted drying, exposure to warm air, etc.) before the printing member 100 is mounted on the plate cylinder of a printing press, or at least before it is actually used. An automated applicator can utilize a rotating rubber or foam disk that resides partially in a well of treatment fluid. The fluid is wicked up onto the disk as it rotates through the well. A conveyor brings the plate edge into contact with the disk outside the well, and the treatment fluid is thereby applied to the plate edge. A similar arrangement can be used in parallel to treat the opposite plate edge. In other methods, plates can be treated in stacks without interleaf paper, using, e.g., a sponge pad.

Application of the treatment fluid is desirably confined substantially to the edge with minimal spread over the surfaces of the printing member. Particularly with manual application some spreading over the plate surfaces is inevitable, and the treatment fluid should not deleteriously affect the performance of the photoresponsive layer 110. For example, the edge treatment should not cause the layer 110 blush a bright color if the treatment fluid inadvertently spreads thereover. (Press shops will often image registration marks close to plate edges and any impairment of them by edge treatment cannot be tolerated.) It is to be understood that a plate surface is “substantially” free of the treatment fluid if the fluid does not spread on the surface more than 2 mm from the edge, and more desirably less than 1 mm from the edge. After treatment application and drying, printing members 100 can be stacked together with or without paper interleaf sheets.

Suitable treatment fluids comprise, consist essentially of, or consist of aqueous alkali (basic) solutions. The pH of the aqueous alkali solution is preferably from 6 to 13.5, more preferably from 8 to 13.5, and particularly preferably from 10 to 13.5. Examples of the alkali agent used in the treatment include inorganic alkali compounds such as sodium silicate, potassium silicate (including metasilicate and dipotassium silicate), potassium hydroxide, sodium hydroxide, lithium hydroxide, sodium, potassium or ammonium salts of secondary or tertiary phosphoric acid, sodium metasilicate, sodium carbonate, and ammonia; and organic alkali compounds such as monomethylamine, dimethylamine, trimethylamine, monoethylamine, diethylamine, triethylamine, monoisopropylamine, diisopropylamine, n-butylamine, di-n-butylamine, monoethanolamine, diethanolamine, triethanolamine, ethyleneimine and ethylenediamine.

The content of the alkali agent in the treatment liquid is preferably in the range from 0.005 to 10% by weight, and particularly preferably from 0.05 to 5% by weight. An organic solvent can optionally be added to the treatment fluid. Suitable organic solvents include ethyl acetate, butyl acetate, amyl acetate, benzyl acetate, ethylene glycol monobutyl acetate, butyl lactate, butyl levulinate, 2-butoxyethanol, methyl ethyl ketone, ethyl butyl ketone, methyl isobutyl ketone, diethylene glycol, cyclohexanone, ethylene glycol monobutyl ether, ethylene glycol monobenzyl ether, ethylene glycol monophenyl ether, benzyl alcohol, methylphenyl carbitol, n-amyl alcohol, methylamyl alcohol, xylene, methylene dichloride, ethylene dichloride and monochlorobenzene. If added, the organic solvent preferably represents 20% by weight or less of the overall composition, and particularly preferably 10% by weight or less.

The treatment fluid may contain one or more surfactants, for example, anionic, cationic, amphoteric and fluorine-based surfactants such as sodium isopropylnaphthalenesulfonate, sodium n-butylnaphthalene sulfonate, alkyldiphenyloxide disulfonate, sodium xylene sulfonate, polyoxyethylene naphthyl ether, sodium N-methyl-N-pentadecyl aminoacetate and sodium lauryl sulfate; and various defoamers. If added, the surfactant(s) preferably represent 0.005 to 10% by weight of the overall composition, preferably 0.5 to 7%, especially 1 to 2%.

The temperature of the treatment fluid is preferably within a range from 15 to 40° C. during application.

Examples of useful edge treatment fluids include:

Formulation 1:
1-2% sodium metasilicate-pentahydrate
1-2% sodium hydroxide (50%)
0.05 to 1% ethylene glycol monobutyl ether
1-2% sodium xylene sulfonate
Balance is water

Formulation 2:
0.5-5% dipotassium silicate
3-7% polyoxyethylene naphthyl ether
Balance is water

Formulation 3:
5% sodium metasilicate-pentahydrate
10% 2-butoxyethanol
Balance is water

During manufacture, the as-yet-unimaged printing plate is typically in web form and finished to a sheet-form final product. Techniques to achieve this include continuously slitting the web (or subsequent sheets) with a rotating blade, continuously cutting a web with a rotating cutter, or a flying shear; or cleaving a web, or sheets, or sheaves of sheets, with a guillotine.

### EXAMPLES

### Example 1

The formulation given in the following table was used as an edge-treatment fluid.

| | Parts by Weight |
|---|---|
| Components | Example 1 |
| DI Water | 95% |
| Sodium hydroxide | 5% |

Sodium hydroxide was supplied by the Aldrich Chemical Company, Milwaukee, Wis. The following develop-on-press (DOP) plates were used during this set of experiments: SONORA NEWS (as supplied by Eastman Kodak Company, Rochester, N.Y.), LIBERTY NXP (Southern Lithoplate, Wake Forest, N.C.) and GEMPLATE (Presstek, Hudson, N.H.). Samples of each plate were cut, using a guillotine, to be smaller (i.e., narrower) than the paper used in a given test.

A Heidelberg GTO 52 sheet-fed press, single color unit with automatic feed and KOMPAC dampening system was used in certain tests conducted. The ink used was TOYO KING AQUALESS ULTRA BLACK MZUS as supplied by Toyo Ink, South Plainfield, N.J. The press blanket used was a PATRIOT 3000, 4 ply, 0.077 gauge as supplied by Day International (Flint Group Print Media North America, Arden, N.C.). A Sakurai Oliver 252 EP II two-color sheet-fed unit with automatic feed was also used in the experiments conducted. Ink and blanket type as the Heidelberg GTO.

### Test

The above treatment fluid was applied to the edges of each DOP plate sample, using a lint-less wipe, and then air dried for 30 seconds before each sample was mounted on press. Dry coating thickness is estimated at about 0.05 g/m².

Each plate was wetted with fountain solution for 20 seconds, then ink rollers were engaged. Imaged areas took ink and acceptable prints were achieved within 25 paper sheets. Backgrounds (non-imaged areas) were clean and 0.5% dots were printing after just 25 impressions. All plates tested demonstrated acceptable print performance.

Printed paper sheets assessed included sheets numbered 25, 50, 100 and sheet 200. The sheets were assessed for ink lines (“paper lines”). A rating of 0-5 was used to assess the treatment and its ability to repel ink: 0 is no repellency (paper lines fully present) and 5 is perfect repellency (no paper lines). A rating of 1 indicates slightly broken paper lines on both sides of a sheet. A rating of 2 indicates broken paper lines on both paper sides. A rating of 3 indicates no paper lines on one side, with partial paper lines on the other paper side. Finally, a rating of 4 indicates no paper lines on one side, with only a faint partial paper line visible on the opposite side.

### Result

| | Paper lines rating after 200 paper sheets | |
|---|---|---|
| | GTO Press | Oliver Press |
| Gemplate, no edge treatment | 0 | 0 |
| Gemplate, edge treatment | 1 | 2 |
| Liberty NXP, no edge treatment | Not tested | Not tested |
| Liberty NXP, edge treatment | Not tested | Not tested |
| Sonora News, no edge treatment | Not tested | Not tested |
| Sonora News, edge treatment | Not tested | Not tested |

### Example 2

The formulation given in the following table was used as an edge-treatment fluid.

| | Parts by Weight |
|---|---|
| Components | Example 2 |
| DI Water | 90% |
| Sodium hydroxide | 10% |

### Test

Assessment is the same as in Example 1.

### Result

| | Paper lines rating after 200 paper sheets | |
|---|---|---|
| | GTO Press | Oliver Press |
| Gemplate, no edge treatment | 0 | 0 |
| Gemplate, edge treatment | 2 | 3 |
| Liberty NXP, no edge treatment | Not tested | Not tested |
| Liberty NXP, edge treatment | Not tested | Not tested |
| Sonora News, no edge treatment | Not tested | Not tested |
| Sonora News, edge treatment | Not tested | Not tested |

### Example 3

The formulation given in the following table was used as an edge-treatment fluid.

| | Parts by Weight |
|---|---|
| Components | Example 3 |
| DI Water | 95% |
| Sodium metasilicate-pentahydrate | 5% |

Sodium metasilicate pentahydrate was supplied by the Aldrich Chemical Company.

### Test

Assessment is the same as in Example 1.

### Result

| | Paper lines rating after 200 paper sheets | |
|---|---|---|
| | GTO Press | Oliver Press |
| Gemplate, no edge treatment | 0 | 0 |
| Gemplate, edge treatment | 1 | 2 |
| Liberty NXP, no edge treatment | Not tested | Not tested |
| Liberty NXP, edge treatment | Not tested | Not tested |
| Sonora News, no edge treatment | Not tested | Not tested |
| Sonora News, edge treatment | Not tested | Not tested |

### Example 4

The formulation given in the following table was used as an edge-treatment fluid.

| | Parts by Weight |
|---|---|
| Components | Example 3 |
| DI Water | 90% |
| Sodium metasilicate-pentahydrate | 10% |

Sodium metasilicate pentahydrate was supplied by the Aldrich Chemical Company.

### Test

Assessment is the same as in Example 1.

### Result

| | Paper lines rating after 200 paper sheets | |
|---|---|---|
| | GTO Press | Oliver Press |
| Gemplate, no edge treatment | 0 | 0 |
| Gemplate, edge treatment | 2 | 3 |
| Liberty NXP, no edge treatment | Not tested | Not tested |
| Liberty NXP, edge treatment | Not tested | Not tested |
| Sonora News, no edge treatment | Not tested | Not tested |
| Sonora News, edge treatment | Not tested | Not tested |

### Example 5

The formulation given in the following table was used as an edge-treatment fluid.

| | Parts by Weight |
|---|---|
| Components | Example 5 |
| DI Water | 93% |
| Sodium hydroxide | 2% |
| Sodium metasilicate-pentahydrate | 2% |
| Ethylene glycol monobutyl ether | 1% |
| Sodium xylene sulfonate | 2% |

Ethylene glycol monobutyl ether and sodium xylene sulfonate were supplied by the Aldrich Chemical Company.

### Test

Assessment is the same as in Example 1.

### Result

| | Paper lines rating after 200 paper sheets | |
|---|---|---|
| | GTO Press | Oliver Press |
| Gemplate, no edge treatment | 0 | 0 |
| Gemplate, edge treatment | 4 | 5 |
| Liberty NXP, no edge treatment | 0 | 0 |
| Liberty NXP, edge treatment | 4 | 5 |
| Sonora News, no edge treatment | 0 | 0 |
| Sonora News, edge treatment | 4 | 5 |

### Example 6

The formulation given in the following table was used as an edge-treatment fluid.

| | Parts by Weight |
|---|---|
| Components | Example 6 |
| DI Water | 85% |
| Ethylene glycol monobutyl ether | 10% |
| Sodium metasilicate-pentahydrate | 5% |

### Test

Assessment is the same as in Example 1.

### Result

| | Paper lines rating after 200 paper sheets | |
|---|---|---|
| | GTO Press | Oliver Press |
| Gemplate, no edge treatment | 0 | 0 |
| Gemplate, edge treatment | 2 | 3 |
| Liberty NXP, no edge treatment | Not tested | Not tested |
| Liberty NXP, edge treatment | Not tested | Not tested |
| Sonora News, no edge treatment | 0 | 0 |
| Sonora News, edge treatment | 2 | 3 |

### Example 7

The formulation given in Example 5 was employed.

### Test

Assessment is the same as in Example 1.

The treatment layer solution was applied using a machine applicator that has the ability to coat the sides of the plates (and very little of the top face of the plate—no more than 1 mm in from the edge), moving at 20 ft/min, while still applying an estimated 0.05-0.1 g/m² of dry treatment formulation. Plate samples then air dry for 15 seconds and are then stacked.

The plate edges were coated using a foam-disk that allows the treatment layer formulation to transfer onto the plate as it passes through the feeder.

Assessment is the same as in Example 1.

### Result

| | Paper lines rating after 200 paper sheets | |
|---|---|---|
| | GTO Press | Oliver Press |
| Gemplate, no edge treatment | 0 | 0 |
| Gemplate, edge treatment | Not tested | 3 |
| Liberty NXP, no edge treatment | Not tested | Not tested |
| Liberty NXP, edge treatment | Not tested | Not tested |
| Sonora News, no edge treatment | Not tested | Not tested |
| Sonora News, edge treatment | Not tested | Not tested |

### Example 8

The formulation given in Example 5 was employed.

### Test

The test followed Example 7, but rubber-disks were used to transfer the treatment layer formulation to the plate edges as each plate passed through the feeder. Assessment is the same as in Example 1.

### Result

| | Paper lines rating after 200 paper sheets | |
|---|---|---|
| | GTO Press | Oliver Press |
| Gemplate, no edge treatment | 0 | 0 |
| Gemplate, edge treatment | Not tested | 4 |
| Liberty NXP, no edge treatment | Not tested | Not tested |
| Liberty NXP, edge treatment | Not tested | Not tested |
| Sonora News, no edge treatment | Not tested | Not tested |
| Sonora News, edge treatment | Not tested | Not tested |

### Example 9

The formulation given in Example 5 was employed.

### Test

The treatment was applied to the edges of each DOP plate sample, using a lint-less wipe and then air dried for 30 seconds. Dry coating thickness is estimated at ˜0.05 g/m². Here, plates were mounted on a Goss INTERNATIONAL NEWSLINER press.

### Result

After 52,000 impressions, paper sheets were assessed.

| | Paper lines rating after 52,000 impressions |
|---|---|
| | Newsliner press |
| Gemplate, no edge treatment | 0 |
| Gemplate, edge treatment | 5 |

Although the present invention has been described with reference to specific details, it is not intended that such details should be regarded as limitations upon the scope of the invention, except as and to the extent that they are included in the accompanying claims.

What is claimed is:

1. A method of imaging and printing with a lithographic printing member comprising (i) a metal substrate having a hydrophilic surface and (ii) over the substrate, a photopolymer oleophilic layer, the substrate and photopolymer layer having a pair of opposed, common edges defining a width of the printing member, the method comprising the steps of:
a) cutting at least one of the edges of the printing member to reduce the width thereof;
b) exposing the printing member to imaging radiation in an imagewise pattern;
c) exposing substantially only the edges to a solution having a pH greater than 6;
d) following the exposing steps, affixing the plate to a printing press; and
e) on the printing press, developing the printing member and thereafter causing transfer of ink in the imagewise pattern to the printing member and thereafter from the printing member to a recording medium having a width greater than the width of the printing member, the ink transfer not imparting edge artifacts to the recording medium.

2. The method of claim 1, wherein the solution is an aqueous solution comprising an alkali agent.

3. The method of claim 2, wherein the alkali agent is an inorganic alkali compound.

4. The method of claim 2, wherein the alkali agent is an organic alkali compound.

5. The method of claim 2, wherein the alkali agent is present in the solution in an amount ranging from 0.005% to 10% by weight.

6. The method of claim 5, wherein the alkali agent is present in the solution in an amount ranging from 0.05% to 5% by weight.

7. The method of claim 1, wherein the solution further comprises an organic solvent.

8. The method of claim 7, wherein the organic solvent is present in the solution in an amount no greater than 10% by weight.

9. The method of claim 1, wherein the solution further comprises a surfactant.

10. The method of claim 9, wherein the surfactant is present in the solution in an amount ranging from 1% to 2% by weight.

11. The method of claim 1, wherein the pH is in the range of 10 to 13.5.

12. The method of claim 1, wherein the solution consists essentially of water and an alkali agent.

13. The method of claim 1, wherein the solution consists essentially of water, an alkali agent, and a surfactant.

14. The method of claim 1, wherein the solution consists essentially of water, an alkali agent, and an organic solvent.

15. The method of claim 1, wherein the solution consists essentially of water, an alkali agent, an organic solvent, and a surfactant.
